(19) United States
(12) Patent Application Publication
(10) Pub. No.: US 2019/0004821 A1
(43) Pub. Date: Jan. 3, 2019

(54) COMMAND INPUT USING ROBUST INPUT PARAMETERS

(71) Applicant: Microsoft Technology Licensing, LLC, Redmond, WA (US)

(72) Inventors: Siddharth UPPAL, Bothell, WA (US); Lawrence WALDMAN, Seattle, WA (US); Vincent SIBAL, Seattle, WA (US); Chad VOSS, Seattle, WA (US); Pedro DEROSE, Redmond, WA (US); Darya VALCHONAK, Redmond, WA (US); Larry JIN, Bellevue, WA (US); Sariah SWICK, Lynnwood, WA (US)

(73) Assignee: Microsoft Technology Licensing, LLC, Redmond, WA (US)

(21) Appl. No.: 15/638,318

(22) Filed: Jun. 29, 2017

(51) Int. Cl. G06F 9/44; G06F 3/01; G06F 3/0481

(52) U.S. Cl. CPC G06F 9/4443; G06F 3/0481; G06F 3/01

(57) ABSTRACT

Examples of the present disclosure describe systems and methods for command input using robust input parameters. In an example, a collaborative communication service may provide one or more commands that may be used to perform actions, retrieve information, or access other functionality. A user may use a command by providing an input comprising a trigger. Based on the trigger, a command may be identified, wherein the command may comprise one or more parameters. An input field may be generated for a parameter of the command, such that a user may enter information for the parameter. Once user input has been received, the received input may be validated according to validation logic associated with the parameter. If validation is successful, user input for a subsequent parameter may be requested, or the command may be submitted for processing. Ultimately, a processing result may be determined based on received user input.

### BACKGROUND

A collaborative communication service may offer command functionality, e.g., for calling third-party services or applications, wherein a user of the collaborative communication service may enter a command having one or more parameters in order to perform an action. However, it may be difficult to enter the correct syntax and/or provide the proper input parameters when entering the command using traditional command-entry techniques.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for command input using robust input parameters. In an example, a collaborative communication service may provide commands that may be used by users of the collaborative communication service to perform actions, retrieve information, or access other functionality. A user may use a command by providing a user input comprising a trigger, wherein the trigger may comprise a string of text, a gesture, an utterance, or by interacting with a button or other user interface element, among other triggers. Based on the trigger, a command associated with the trigger may be identified, wherein the command may comprise one or more parameters. The parameters may be evaluated or otherwise used when processing the command. As an example, a command for accessing or searching for a file (e.g., associated with a third-party service) may comprise a parameter for a file name, last modified date, and/or a file type, among others. In some examples, a command may be entered in a text box, in a command-entry box, or in a command line, among other locations. As should be appreciated, commands for interacting with different applications and/or services may involve different syntax, a different combination of parameters or parameter types, different underlying logic, etc.

To facilitate proper input of a variety of commands associated with a variety of services and/or applications, one or more structured input interfaces may be provided. In aspects, a structured input interface may be provided for each command, which may include one or more input fields for accepting and validating one or more parameters, for properly syntactically formatting the command based on preconfigured validation logic associated with the input interface, and for invoking at least one function associated with a service and/or application. That is, a parameter of a command may be requested from the user via an input field, such that the user may enter information. In an example, presenting the input field may comprise determining an input type associated with the parameter. For example, if a parameter is a date, a calendar or other date entry interface may be presented as part of the input field for the user to input the parameter (e.g., date). In examples, an input description may be displayed, thereby providing information to the user regarding what type of input is expected for the parameter. Once user input has been received for the parameter, the received input may be validated based on validation logic. In some examples, the validation logic may comprise a local evaluation of the user input. In other examples, validation logic may indicate one or more external validators that may be used to validate the user input.

If the user input is successfully validated, a subsequent input field associated with a subsequent parameter may be presented to the user for user input. In an example, the subsequent parameter may be determined based on previously received user input. In another example, there may not be subsequent parameters to provide, such that the command may instead be submitted for processing. As a result, the command may be processed based on the received user input for the one or more parameters, and a processing result may be received. However, if the user input is not successfully validated, the user may be prompted to re-enter information for the parameter using the input field. In some examples, a hint, error information, or other information may be provided to the user.

Thus, according to aspects disclosed herein, command input via a structured input interface may be achieved using parameters, each of which may be associated with an input description, an input type, and/or validation logic. As compared to traditional command-entry techniques, aspects disclosed herein provide an improved user experience due to greater information clarity and user input validation prior to command submission, among other benefits.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for command input using robust input parameters.

FIG. 2 illustrates an overview of an example method for receiving command input using robust input parameters.

FIG. 3 illustrates an overview of an example command with which aspects of the present disclosure may be practiced.

FIGS. 4A-4D illustrate overviews of example graphical user interfaces relating to command input using robust input parameters.

FIG. 5 illustrates an overview of an example graphical user interface relating to command input using robust input parameters.

FIGS. 6A-6D illustrate overviews of example mobile graphical user interfaces relating to command input using robust input parameters.

FIG. 7 is a block diagram illustrating example physical components of a computing device with which aspects of the disclosure may be practiced.

FIGS. 8A and 8B are simplified block diagrams of a mobile computing device with which aspects of the present disclosure may be practiced.

FIG. 9 is a simplified block diagram of a distributed computing system in which aspects of the present disclosure may be practiced.

FIG. 10 illustrates a tablet computing device for executing one or more aspects of the present disclosure.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In an example, a user of a user device may use a collaborative communication service to collaborate with one or more other users. The collaborative communication service may provide commands that may be used to perform an action, access information, or access other functionality, such as provided by third-party services and/or applications, the result of which may be shared with users of the collaborative communication service. However, traditional command-entry techniques (e.g., text-based command entry) may be cumbersome to inexperienced users, prone to typographical errors, and obscure the nature of the inputs that are expected by a command.

Accordingly, the present disclosure provides systems and methods for command input using robust input parameters. In some examples, a command may comprise one or more parameters, wherein each parameter may be associated with one or more input attributes. As an example, an input attribute may comprise an input type (e.g., text, numeric, date input, etc.), validation logic (e.g., allowed or disallowed characters, expected date ranges, a reference to an external validation reference, etc.), or an input description (e.g., a hint regarding what type of input is expected, a parameter name, etc.), among other input attributes. In an example, a command may be associated with a trigger, wherein the trigger may cause an input field associated with a parameter of a command to be presented to a user for user input. User input may be requested by input fields associated with parameters of a command sequentially, simultaneously, or a combination thereof. Once a confirmation action is received from the user, the user input may be validated according to validation logic. If the input is validated, user input may be received at yet another input field for the command, or, if there are no further parameters of the command, the command may be submitted. As a result, aspects disclosed herein may provide a structured input interface that may provide more information to a user about expected inputs, as well as offer input validation for one or more parameters prior to submitting a command, thereby enabling a user to more easily interact with a command as compared to traditional command-entry techniques.

In an example, a collaborative communication service may be an electronic communication platform, such as an email messaging system, an instant messaging system, or a social media platform. In another example, a collaborative communication service may enable users to engage in document sharing or collaborative editing, or interact with external services and/or applications. In some examples, the collaborative communication service may comprise a chatbot, wherein the chatbot may receive input from a user and process the received input to provide a processing result to the user. In some examples, a chatbot may be associated with an external service. The collaborative communication platform may receive and process any of a variety of user inputs, including, but not limited to, text input, speech input, or visual input. While examples herein may be discussed in the context of a collaborative communication service, it will be appreciated that aspects may be applied to other contexts as well.

A collaborative communication service may provide command functionality, wherein a user of the collaboration service may perform actions, access information, or access other features (e.g., of the collaborative communication service, of an external service, etc.) using a command. In some examples, a user may compose commands via a structured input interface using keyboard input, mouse input, touch input, or a combination thereof. In other examples, speech input, gesture input, or other input techniques may be used. Commands may be provided by the collaborative communications service, or may be authored by an external service. For example, the collaborative communication service may provide a protocol or application programming interface (API) which may be used by the external service to author or provide commands that may be used by users of the collaborative communication service.

In an example, a structured input interface may be used to request user input for a command comprising one or more parameters. As described herein, an input field may be generated for a parameter, which may be used by a user of a user device to input information for the parameter. In some examples, parameters of a command may be structured hierarchically (e.g., as a tree), wherein user input received for previous parameters may be used to determine the next parameter for which to request user input. The structured input interface may provide input validation, wherein user input received by an input form may be validated to confirm that the received input is of a type, format, or otherwise satisfies validation logic as may be expected for the parameter of the command. The structured input interface may then generate a syntactically correct command based on the received user input for the command parameters, thereby improving the ease with which a user may compose a command for a collaborative communication environment.

A structured input interface may be activated by one or more triggers associated with a command. A trigger may be a text string, a user interface element (e.g., a button, a menu item, etc.), a gesture, or an utterance that maybe used by a user to activate an input interface associated with the command for receiving user input. Thus, as a result of receiving or detecting a trigger, an input interface for the command may be provided to the user to receive user input. As an example, a parameter may comprise a date input, a text input, a numeric input, an image input, or a file location input, among other input types. In some examples, a custom input type may be defined. In other examples, an input type may be defined dynamically or may be a combination of one or more other input types. In an example, suggestions may be displayed as a user is providing input to an input field, such as auto-complete suggestions or frequently used parameters, among others. In another example, an input field for a parameter may be localized based on a determined location or language for a user or a user device, thereby providing a user experience that conforms to a determined locale.

When a confirmation action is received, user input received via an input field associated with a parameter may be validated. In an example, a confirmation action may comprise a keyboard input (e.g., an enter, tab, space, or arrow keypress, etc.), a mouse input (e.g., clicking a next button, clicking on a subsequent input field, etc.), or recognizing that a user input is complete (e.g., that a user has input a valid date, that a user is done speaking, etc.), among other confirmation actions. Validating user input may comprise evaluating validation logic associated with the parameter. In an example, validation logic may comprise logic associated with an input type of the parameter (e.g., confirming that a numeric input type comprises a number, confirming that a date input type comprises a valid date, etc.). In another example, validation logic may comprise an external validation reference. The external validation reference may comprise a uniform resource locator (URL), a unique identifier, or other reference. At least a part of the user input may be provided to an external validator using the external validation reference, which may provide, in response, an indication of whether the user input is valid. In some examples, additional information may be provided in response, such as an indication as to the next parameter that should be provided to the user in the event of a successful validation, or an error message that may be displayed or interpreted in the event of a failed validation. While example validation logic is described herein, it will be appreciated that other validation logic and/or techniques may be used.

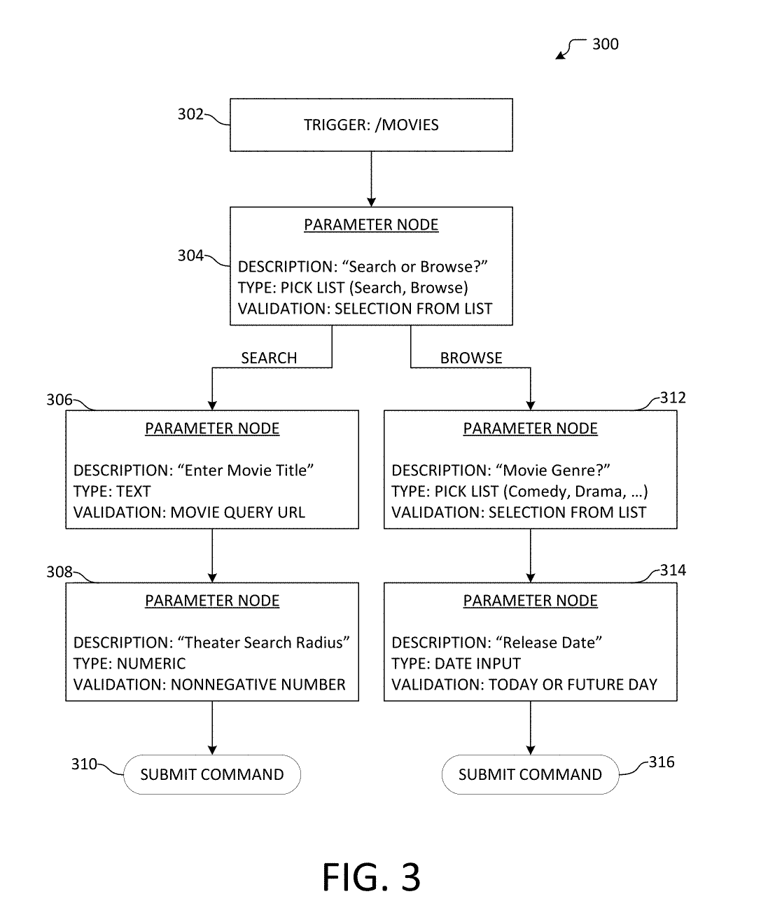

In some examples, parameters may be structured or arranged such that subsequent parameters that are used to generate input fields for receiving user input may be determined based on user input that has already been received for previous parameters. As will be discussed below with respect to FIG. 3, parameters of a command may be represented using a tree structure. For example, depending on a first user input for a first parameter, different parameters (e.g., branches of the tree) may be used. Given that the user may be guided through the parameters, the branched nature of the parameters may be more apparent or easier to comprehend as compared to a traditional command-entry techniques wherein the user must intuit the conditional nature of command parameters when entering a command.

A parameter may be stored or associated with a command (e.g., as part of a command object, in a command data store, etc.), such that the parameter of the command may be accessed from storage or based on the association when a trigger is received or when identifying a subsequent parameter. In another example, a parameter may be retrieved from a remote or external service, such that a parameter may be dynamically determined by the remote service based on any of a variety of factors, including, but not limited to, user identification or authentication information, a conversation session of which the user is a part, or context information. It will be appreciated that a parameter may be determined using any of a variety of techniques. As another example, at least a part of the dynamic determination may be performed at a user device.

Once user input has been received for parameters of a command, the command may be submitted. Submitting the command may comprise providing at least a part of the received user input to an external request processor, processing the command locally, or a combination thereof. The command may be used to generate a response, wherein the response may comprise information or a processing result. In the context of a collaborative communication environment, an electronic communication may be generated, which may be communicated to other users of the collaborative communication environment. In other examples, the command may cause an action to be taken within the collaborative communication environment, or at an external service. While examples may be discussed herein with respect to submitting a command, it will be appreciated that any of a variety of other acts may be performed.

In some examples, one or more parameters of a command may be submitted or otherwise used to generate a processing result periodically (e.g., on receipt of a confirmation action for a parameter, after a period of inactivity by the user, etc.). Thus, rather than submitting the command after the user has completed inputting information (e.g., submitting the command once), periodically generating or updating the processing result may provide a user with a preview, partial, or incomplete view which may be used by the user to adjust further user input, revise previous user input, or determine other information prior to ultimately submitting or invoking the command.

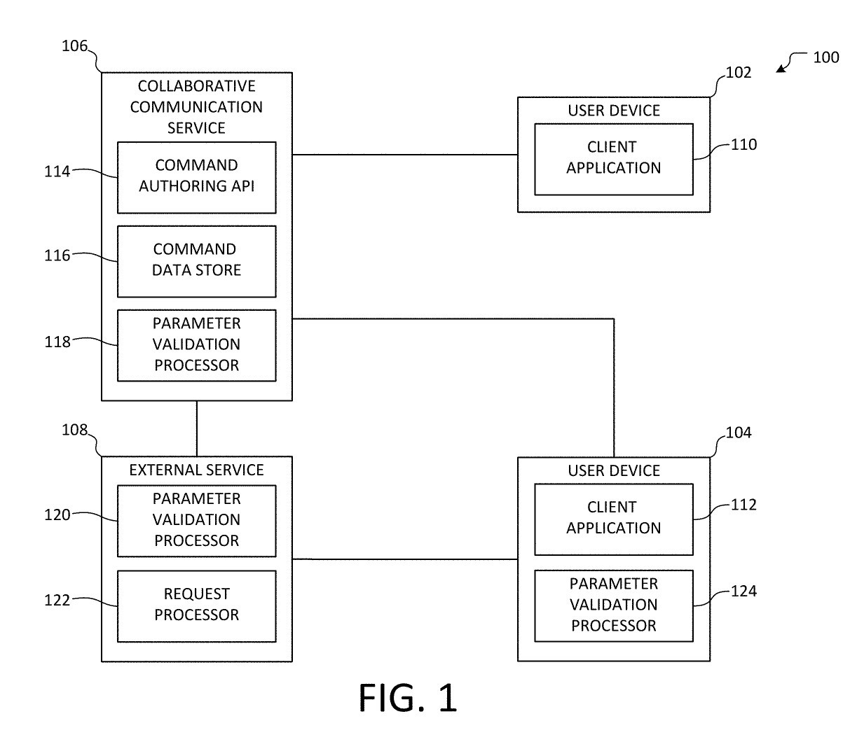

FIG. 1 illustrates an overview of an example system 100 for command input using robust input parameters. As illustrated, system 100 comprises user devices 102 and 104, collaborative communication service 106, and external service 108. User devices 102 and 104 may each be a computing device, including, but not limited to, a mobile computing device, a tablet computing device, or a personal computing device. Collaborative communication service 106 may be an electronic communication platform, such as an email messaging system, an instant messaging system, or a social media platform. In another example, a collaborative communication service may enable users to engage in document sharing or collaborative editing. External service 108 may be any type of service, including, but not limited to, a website, a file sharing service, or an electronic communication platform. In some examples, external service 108 may be an authentication service, or may request authentication information from a user prior to granting access to one or more services of external service 108.

As illustrated, users of user devices 102 and 104 may communicate using collaborative communication service 106. In an example, client applications 110 and 112 of user devices 102 and 104, respectively, may be used to communicate with collaborative communication service 106. Client applications 110 and 112 may each be any of a variety of applications, including, but not limited to, a web browser executing a website or web-based application, a native client application, or an email, instant messaging, or other communication application. User device 104 is also illustrated as interacting with external service 108. In some examples, client application 112 of user device 104 may communicate with external service 108.

Collaborative communication service 106 comprises command authoring API 114, command data store 116, and parameter validation processor 118. In an example, command authoring API 114 may be used to create or provide commands to collaborative communication service 106, according to aspects disclosed herein. As an example, external service 108 may provide a command comprising one or more triggers and one or more parameters to collaborative communication service 106 using command authoring API 114. In some examples, the command may be provided as an XML or JSON object, among other data types. In other examples, command authoring API 114 may comprise a website or application that may be used to generate a command, wherein triggers and parameters may be specified using the website or application. While example authoring techniques are described herein, it will be appreciated that a command may be created using any of a variety of techniques.

Command data store 116 may store one or more commands, such as commands that are authored using command authoring API 114 and/or commands that are provided by collaborative communication service 106. In some examples, command data store 116 may be a database or a storage device, among other data stores. In some examples, commands stored by command data store 116 may be associated with one or more access restrictions, wherein access to one or more commands may be restricted or conditioned on credentials or other permissions associated with user devices 102 and 104, and/or users of user devices 102 and 104. While command data store 116 is illustrated as part of collaborative communication service 106, it will be appreciated that command data store 116 may be remote from collaborative communication service 106, such as a networked storage device. In some examples, a user device may comprise a command data store.

Parameter validation processor 118 may validate user input for parameters of commands according to aspects disclosed herein. As an example, parameter validation processor 118 may access validation logic associated with a parameter and evaluate the validation logic based on a user input received for the parameter (e.g., by an input field). In some examples, parameter validation processor 118 may communicate with parameter validation processor 120 of external service 108. In such examples, parameter validation processor 118 may identify an external validation reference associated with or specifying parameter validation processor 120 as an external validator. As a result, parameter validation processor 118 may provide at least a part of received user input for a parameter to parameter validation processor 120. As a result, parameter validation processor 120 may perform validation (e.g., as may be specified by external service 108) and provide a validation result to parameter validation processor 118.

As illustrated, external service 108 comprises parameter validation processor 120 and request processor 122. Similar to parameter validation processor 118, parameter validation processor 120 may validate user input for parameters of commands according to aspects disclosed herein. As an example, parameter validation processor 118 may access validation logic associated with a parameter and evaluate the validation logic based on a user input received for the parameter. In some examples, parameter validation processor 120 may receive validation requests directly from a device validating a user input for a parameter (e.g., user devices 102 or 104), or may receive validation requests from an intermediary (e.g., collaborative communication service 106).

Request processor 122 may process requests that may be generated as a result of submitting a command comprising validated user input. As an example, request processor 122 may receive a request from one of user devices 102 or 104, or indirectly via collaborative communication service 106. In some examples, request processor 122 may generate an output, which may be provided in response to the received request. While system 100 is illustrated such that request processor 122 is part of external service 108, it will be appreciated that other components may comprise a request processor, such as collaborative communication service 106 and/or one or more of user devices 102 and 104.

Returning to user device 104, user device 104 further comprises parameter validation processor 124, which may perform parameter validation using similar techniques as were described above with respect to parameter validation processor 118 and/or parameter validation processor 120. It will be appreciated that when validating a user input received at user device 104, one or more of parameter validation processors 124, 118, and 122 may be used to validate the received input. Further, in some examples, a parameter validation processor may validate input requested by one or more input fields simultaneously.

In an example, a user of user device 104 may use client application 112 to compose a command, the result of which may be transmitted as an electronic communication via collaborative communication service 106. The user may provide a trigger, such as a portion of text (e.g., “/movies” or “@Visual Basic,” etc.), a speech utterance, and/or a gesture, among other triggers. In examples, the trigger may be associated with or defined by the command, or may be defined by collaborative communication service 106. As a result of receiving the trigger, client application 112 may access a command associated with the trigger. In an example, the command may be stored locally at user device 104, or may be retrieved from command data store 116 of collaborative communication service 106. In some examples, the command may have been created by external service 108 using command authoring API 114 as was described above.

Based on the accessed command, one or more parameters of the command may be presented to the user by client application 112 as input fields. In some examples, presenting a parameter may comprise identifying an input type and displaying an input field associated with the identified input type. As an example, a calendar may be displayed for a date input type, a list of items may be displayed for a pick list, or a grid of images may be displayed for an image input. In some examples, a custom user interface may be specified by a parameter. In other examples, an on-screen keyboard comprising letters and/or numbers may be presented, if the user device is determined to be a touch-screen device. While example input types and interfaces are described herein, it will be appreciated that any of a variety of input types and/or interfaces may be used.

When a confirmation action is received, user input received by the input field may be validated. In some examples, validating the user input may comprise accessing validation logic associated with the parameter and evaluating the associated validation logic. In other examples, the validation logic may comprise an external validation reference, which may refer to one or more of parameter validation processors 118, 122, and/or 124. If the user input is validated, a subsequent parameter may be used to generate a subsequent input field, or the command may be submitted. In an example, displaying the subsequent input field may comprise identifying a subsequent parameter from a tree-like structure, as will be discussed in greater detail below with respect to FIG. 3. If, however, the user input is not validated, the user may be prompted to re-enter or revise input to the input field. In some examples, a hint may be displayed to the user.

Eventually no further parameters may be available for the command, it may be determined that user input for a set of required parameters has been received, or a user indication may be received, among other examples. As a result, received user input associated with one or more of the parameters of the command may be submitted. In some examples, submitting the command may comprise performing local processing (e.g., by client application 112 and/or another application executing on user device 104), generating a request to a remote device comprising at least a part of the received user input, or any combination thereof. In some examples, the accessed command may comprise a URL or other reference, which may be used when generating a request. In some examples, the reference may specify a server computing device, a format for a request, and/or a set of expected parameters.

It will be appreciated that additional or alternative command submission techniques may be used without departing from the spirit of this disclosure. As an example, a command may be submitted periodically, such that one or more parameters comprising received user input may be used to provide a preview, partial, or incomplete view of the processing result that may ultimately be generated once the user ultimately submits the command. Thus, while examples herein may be discussed with respect to submitting a command after a user has completed inputting information, it will be appreciated that a command may be submitted in any of a variety instances.

A processing result for the command may be received by client application 112. In some examples, the command result may be received from local processing and/or remote processing of the command and associated user input, as discussed above. In some examples, the processing result may be displayed as a draft electronic communication, wherein a user of user device 104 may further revise the processing result or add additional content relating to the processing result prior to sending the electronic communication. In other examples, the processing result may be added to a conversation of collaborative communication service 106 as a standalone electronic communication. In an example, at least a part of the received user input for the command may be communicated in addition to the processing result, thereby enabling other users of collaborative communication service 106 to view at least a part of the user input that was used to generate the processing result. Client application 110 of user device 102 may receive the electronic communication from user device 104 via collaborative communication service 106, thereby enabling a user of user device 102 to view the processing result that was generated as a result of user input at user device 104. While command input and related techniques are discussed above with reference to collaborative communication service 106 and electronic communications, it will be appreciated that such techniques may be applied to any of a variety of other command-entry scenarios.

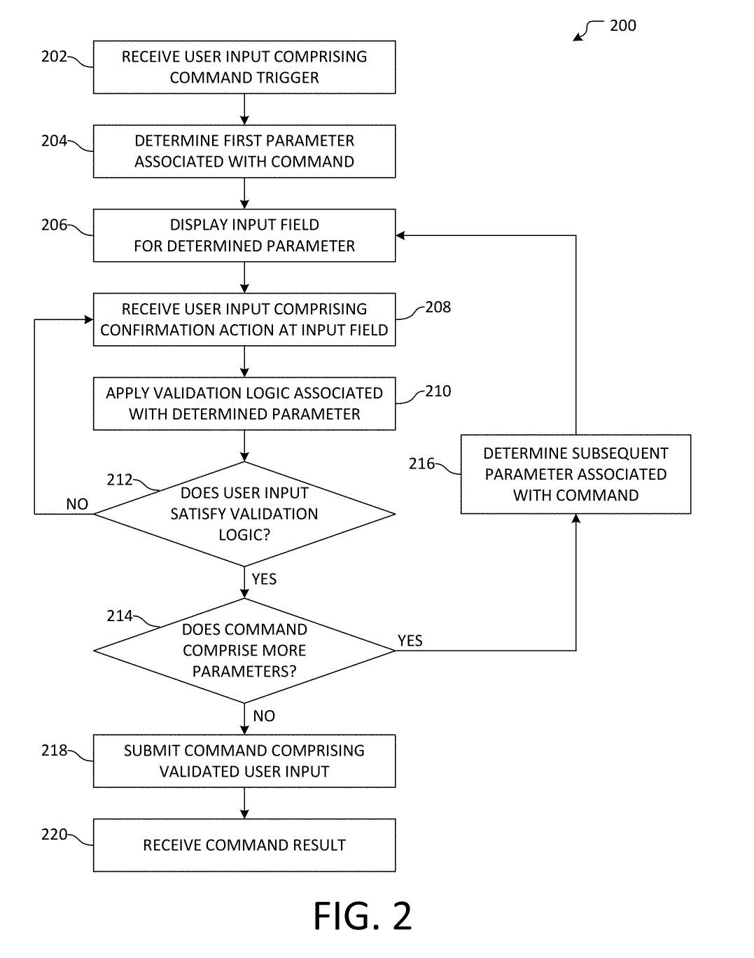

FIG. 2 illustrates an overview of an example method 200 for receiving command input using robust input parameters. Aspects of method 200 may be performed by one or more computing devices, including, but not limited to, a mobile computing device, a personal computing device, a tablet computing device, a server computing device, or a distributed computing device. As an example, aspects of method 200 may be performed by user device 104, collaborative communication service 106, and/or external service 108 in FIG. 1.

Method 200 begins at operation 202, where a user input comprising a command trigger may be received. In an example, a trigger may be a portion of text (e.g., “/movies” or “@Visual Basic,” etc.), a speech utterance, and/or a gesture, among other triggers. In some examples, a trigger may comprise an initial trigger and a command trigger, wherein the initial trigger indicates that a command trigger associated with a command will follow. For example, for a text-based trigger, the initial trigger may be “/” or “@”, while a speech-based trigger may comprise a hot word or hot phrase (e.g., “okay computer” or “hey computer”) as an initial trigger, followed by a command trigger. In some examples, a command may be associated with multiple triggers. In other examples, the user input may comprise interacting with a user interface element, such as a button, an icon, or a menu item.

Flow then progresses to operation 204, where a first parameter associated with the command may be determined. Determining the first parameter may comprise accessing a command associated with the command trigger received at operation 202. In an example, the command may be stored local and/or remotely. In some examples, the command may comprise one or more parameters, each of which may be associated with input attributes. In other examples, the first parameter may be determined dynamically based on any of a variety of factors, including, but not limited to, user identification or authentication information, a conversation of which the user is a part, or context information. As will be discussed in greater detail below with respect to FIG. 3, parameters of a command may comprise a tree, such that different subsequent parameters may be used depending on a user input received for previous parameters.

Moving to operation 206, an input field for the determined parameter may be displayed. Displaying the input field may comprise evaluating input attributes associated with the first parameter, such as an input type (e.g., text, numeric, date input, etc.) and/or an input description. As a result, an appropriate input field for the input type may be generated for display. In some examples, the input field may display at least a part of an associated input description. As an example, for a flight search command, a first parameter may comprise a departure date parameter. The input type may be date input, and the input description may be “Departure Date?”. In other examples, displaying the input field may comprise displaying a keyboard, number pad, or date picker on a touch screen device. While example input types and user interface elements are described herein, it will be appreciated that any of a variety of others may be used.

At operation 208, user input comprising a confirmation action may be received at the displayed input field. In an example, a confirmation action may comprise a keyboard input (e.g., an enter, tab, space, or arrow keypress, etc.), a mouse input (e.g., clicking a next button, clicking on a subsequent input field, etc.), or recognizing that a user input is complete (e.g., that a user has input a valid date, that a user is done speaking, etc.), among other confirmation actions.

Flow progresses to operation 210, where validation logic associated with the determined parameter may be applied. In an example, the validation logic may be an input attribute associated with the determined parameter. In another example, the validation logic may be default validation logic associated with an input type of the determined parameter, wherein the validation logic may comprise logic associated with an input type of the parameter (e.g., confirming that a numeric input type comprises a number, confirming that a date input type comprises a valid date, etc.). In some examples, validation logic may comprise an external validation reference. The external validation reference may comprise a uniform resource locator (URL), a unique identifier, or other reference. At least a part of the user input may be provided to an external validator using the external validation reference, which may provide, in response, an indication of whether the user input is valid. In other examples, multiple validations may be performed, which may be local, remote, or any combination thereof. In an example, the external validator may be provided by the external service (e.g., parameter validation processor 120 of external service 108 in FIG. 1). In another example, an external validator may be provided by an external service as a distributable, which may be executed or parsed locally at a user device (e.g., in a sandbox, as a plugin, etc.)

At determination 212, it may be determined whether the user input satisfies the validation logic. If the user input does not satisfy the validation logic, flow branches “NO” and returns to operation 208, where new or revised user input may be received. In some examples, a hint, explanation, or other information may be provided to the user, which may aid the user in satisfying the validation logic required by the determined parameter. Flow may loop between operations 208 and 212 until the received user input is successfully validated.

If, however, the user input satisfies the validation logic, flow instead branches “YES” and continues to determination 214, where it may be determined whether the command comprises more parameters. Determining whether there are more parameters may comprise evaluating whether there are parameters of the command for which user input has not yet been received. In another example, it may comprise determining whether there are any remaining required parameters, wherein a user may then indicate that the command should be submitted without completing all of the optional parameters.

If it is determined at determination 214 that the command does comprise more parameters, flow branches “YES” to operation 216, where a subsequent parameter may be determined. In an example, parameters may be structured or arranged such that subsequent parameters that are used to receive user input may be determined based on user input that has already been received for previous parameters. As an example, depending on the received user input for the first parameter, a different parameter (e.g., branches of the tree) may be determined as the subsequent parameter. In another example, the subsequent parameter may be determined dynamically according to aspects disclosed herein. Flow continues looping through operations 206-214 using the determined subsequent parameter, such that additional user input may be received using an input field for the parameter, which may then be validated. Flow may loop as long as there are remaining parameters for the command.

If, however, it is determined at determination 214 that the command does not comprise more parameters, flow branches “NO” to operation 218, where the command may be submitted. Submitting the command may comprise formatting at least a part of the received user input into a syntactically correct command for submission to an external request processor, processing the command locally, or a combination thereof. In some examples, a visual indication may be provided to the user that processing and/or formatting is occurring and, in some examples, the visual indication may comprise a progress indicator. It will be appreciated that, in other examples, a command may be periodically submitted according to aspects disclosed herein.

Moving to operation 220, a processing result may be received. In an example, the processing result may be received as a result of local and/or remote processing. In the context of a collaborative communication environment, an electronic communication may be generated based on the processing result, which may be communicated to other users of the collaborative communication environment. In other examples, the processing result may cause an action to be taken at the local computing device or at an external service, or a combination thereof. Flow terminates at operation 220.

FIG. 3 illustrates an overview of an example command 300 with which aspects of the present disclosure may be practiced. In an example, aspects of command 300 may be stored as a JSON or XML object, as one or more entries, nodes, and/or relationships in a database, or as an executable code segment. As illustrated, command 300 comprises trigger 302. Trigger 302 comprises a text-based trigger of “/movies”. In an example, a user may enter “/movies” in a text field, which may then cause input fields for the parameters of command 300 to be presented to the user, thereby enabling the user to compose a command for command 300. As discussed above, a trigger may be a text string, a user interface element (e.g., a button, a menu item, etc.), a gesture, or an utterance that maybe used by a user to activate the command for user input.

Parameter node 304 may be a root node of a tree, wherein branches may stem from parameter node 304. As illustrated, command 300 is comprised of two branches: the first branch is comprised of nodes 306, 308, and 310, while the second branch is comprised of nodes 312, 314, and 316. User input that is received for parameter node 304 may be used to determine which branch of command 300 is used to request user input. Thus, if a user input is identified to match trigger 302, parameter node 304 may be used to request user input. Parameter node 304 is illustrated as having several input attributes, including an input description, an input type, and validation logic. Thus, when requesting user input based on parameter node 304, a pick list comprising “Search” and “Browse” may be displayed to a user, along with the description, indicating that the input is asking the user whether they would prefer to “Search or Browse?” Once an input is received (e.g., comprising a confirmation action as described herein), the input may be validated by determining that the selection was a valid selection from the pick list. In another example, no validation logic or default validation logic may be used instead.

Depending on whether the user selected search or browse, command input either branches “SEARCH” or “BROWSE”. With reference first to the “SEARCH” branch, the user may then be asked to “Enter Movie Title”, as illustrated by input node 306. Given that the input type of parameter node 306 is text, a text box or other text input mechanism may be presented to the user. In some examples, an on-screen keyboard or other text-input element may be displayed so that the user may enter text on a touchscreen device. The validation logic is illustrated as “MOVIE QUERY URL”, which may be an external validation reference, thereby allowing external validation of the input movie title to be performed.

If the user input is validated, the user may then be prompted to input a “Theater Search Radius” using numeric input based on parameter node 308. In some examples, an on-screen number pad may be displayed, such as on a touchscreen device. The validation logic specifies that the user input should be a nonnegative number, thereby ensuring that the user provides a valid search radius for the command. Finally, if the user input at input node 308 is validated, the command may be submitted at node 310. Submitting the command may comprise providing at least a part of the user input from nodes 304, 306, and/or 308. In some examples, node 310 may specify a URL or other reference that may be used to submit the command according to aspects disclosed herein.

Turning now to the “BROWSE” branch, the user may then be asked to select a “Movie Genre?”, as illustrated by input node 312. Given that the input type of parameter node 312 is a pick list, a list or other selection mechanism may be presented to the user. The list may comprise a series of movie genres, such as “Comedy” or “Drama”. The validation logic may comprise determining that the selection was a valid selection from the pick list. In another example, no validation logic or default validation logic may be used instead.

If the user input is validated, the user may then be prompted to indicate a “Release Date” to refine the results that may be returned at parameter node 314. Given that the type of input is indicated as date input, a calendar or other date input interface may be presented to the user. The validation logic specifies that the user input should be a current or future date, thereby ensuring that the user provides a valid date input for the command. Finally, if the user input at input node 314 is validated, the command may be submitted at node 316. Submitting the command may comprise providing at least a part of the user input from nodes 304, 312, and/or 314. In some examples, node 316 may specify a URL or other reference that may be used to submit the command according to aspects disclosed herein, which may be different than the reference used to submit a command based on node 310.

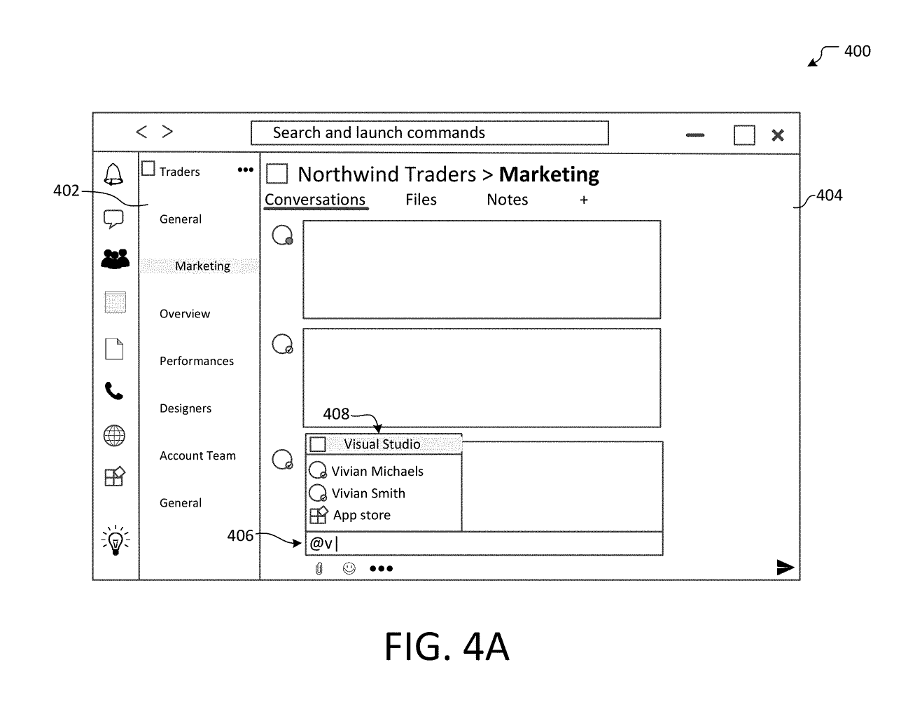

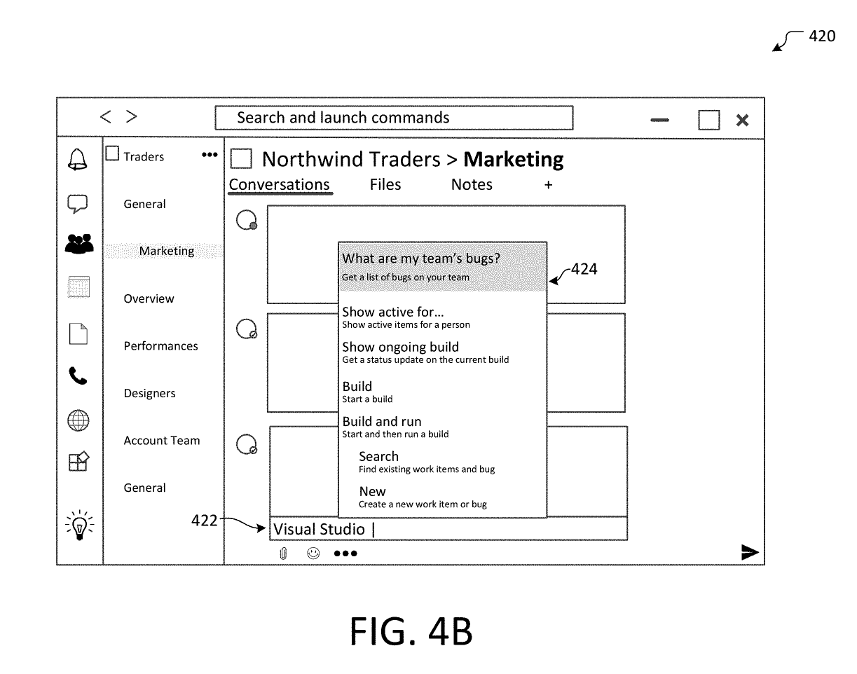

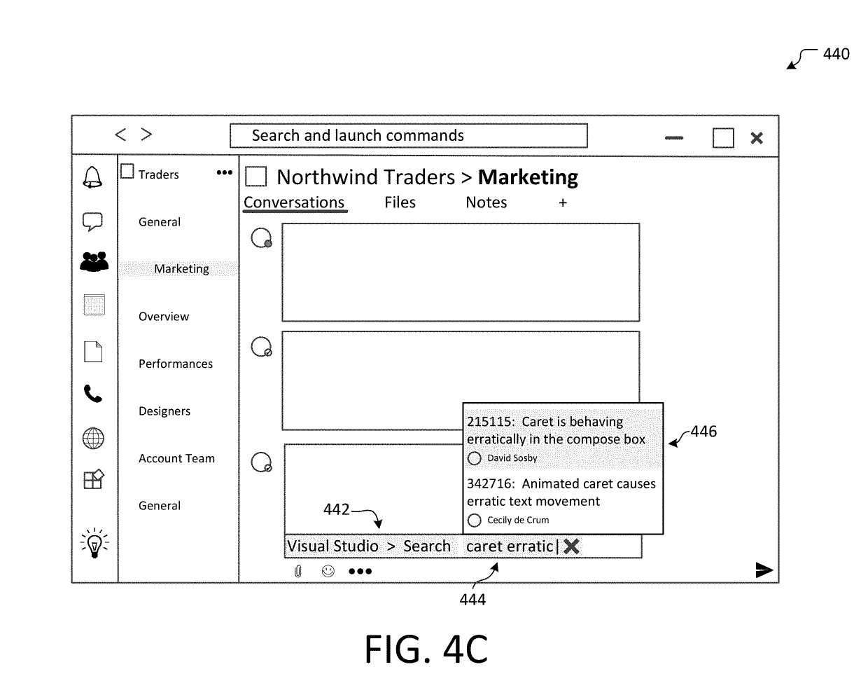

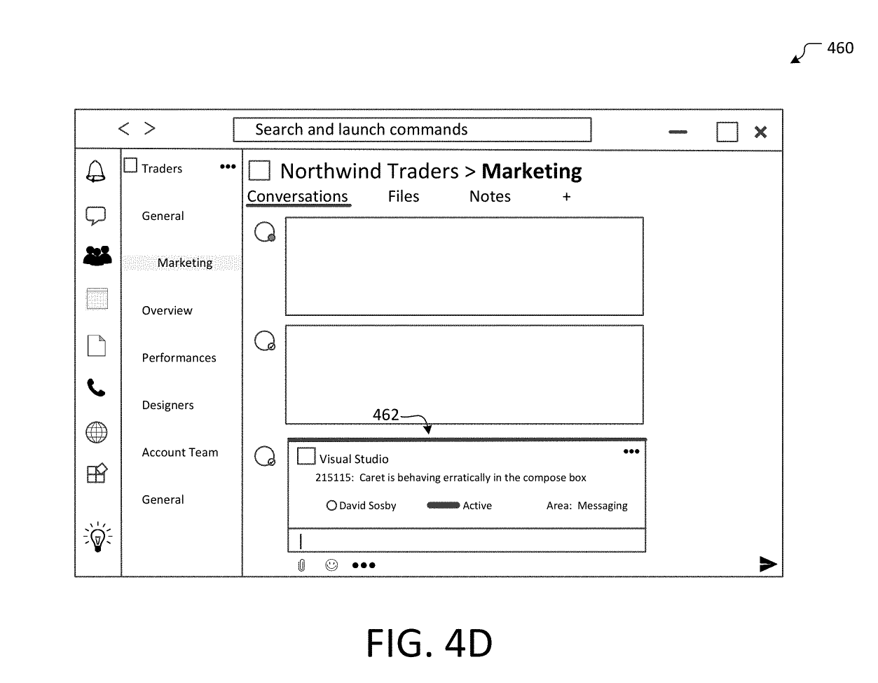

FIGS. 4A-4D illustrate overviews of example graphical user interfaces (GUIs) relating to command input using robust input parameters. In an example, a client application such as client applications 110 or 112 in FIG. 1 may display aspects discussed below with respect to FIGS. 4A-4D.

Turing to FIG. 4A, example GUI 400 is illustrated has having conversation pane 402 and message pane 404. In some examples, GUI 400 may be a user interface for a collaborative communication environment, such as collaborative communication environment 106 in FIG. 1. In such examples, message pane 404 may display messages of users of the collaborative communication service. Input box 406 may be used by a user to compose electronic messages to communicate with other users. In an example, input box 406 may also be used to input commands according to aspects disclosed herein.

As illustrated, a user may input a trigger into input box 406, starting with “@v”. As a result of identifying “@” as an initial trigger, autocomplete suggestions 408 may be presented to the user. In an example, the user may select the command “Visual Studio” from autocomplete suggestions 408. With reference now to GUI 420 in FIG. 4B, “Visual Studio” is illustrated as command 422 as a result of a user selecting it from autocomplete suggestions 408 in FIG. 4A. Pick list 424 may be presented to the user, wherein the pick list may be associated with a first parameter of the “Visual Studio” command. In an example, a user may select an entry from pick list 424 by typing at least a part of the text associated with a pick list entry or by clicking or tapping on a pick list entry, among other techniques.

As discussed above, subsequent parameters of a command may vary depending on the input received at current and/or previous parameters. With reference to FIG. 4C, a user may have selected “Search” from pick list 424 in FIG. 4B, as illustrated by confirmed input field 442. A next input field for a next parameter may be displayed, as depicted by input field 444. In some examples, a user may return to previous input fields to change the input that was previously provided. In some examples, subsequent inputs that were received after the user's revised input may no longer be relevant and may be reset. In other examples, the user may continue based on the previously-provided input.

Input field 444 is a text-entry input, wherein the user may enter text. Suggestions box 446 may update based on input received from the user, such that the user may select a suggestion displayed by suggestion box 446 as input for input field 444. As illustrated, a search for “caret erratic” may have been entered into input field 444, such that suggestion box 446 comprises search results relating to “caret erratic.” As described above, the user may move in between input fields using any of a variety of techniques, including keypresses and/or gestures, among others. A command may be submitted based on determining that there are no remaining parameters for which user input should be received, or based on determining that received user input is sufficient (e.g., required parameters have been entered) to submit the command.

FIG. 4D illustrates GUI 460, wherein the command comprising previously-discussed parameters may have been submitted (e.g., a search result from suggestion box 406 in FIG. 4C may have been selected), thereby generating processing result 462. In the instant example, processing result 462 may be a computer bug from Visual Studio that was accessed as a result of user input received at the input fields for parameters as discussed above. A user may then communicate the processing result to other members of the conversation, thereby enabling other users to view the information that the user accessed by composing and submitting the command. As an example, the processing result may be communicated in the conversation as a separate electronic communication, or the user may author an electronic communication that comprises the processing result in conjunction with additional content.

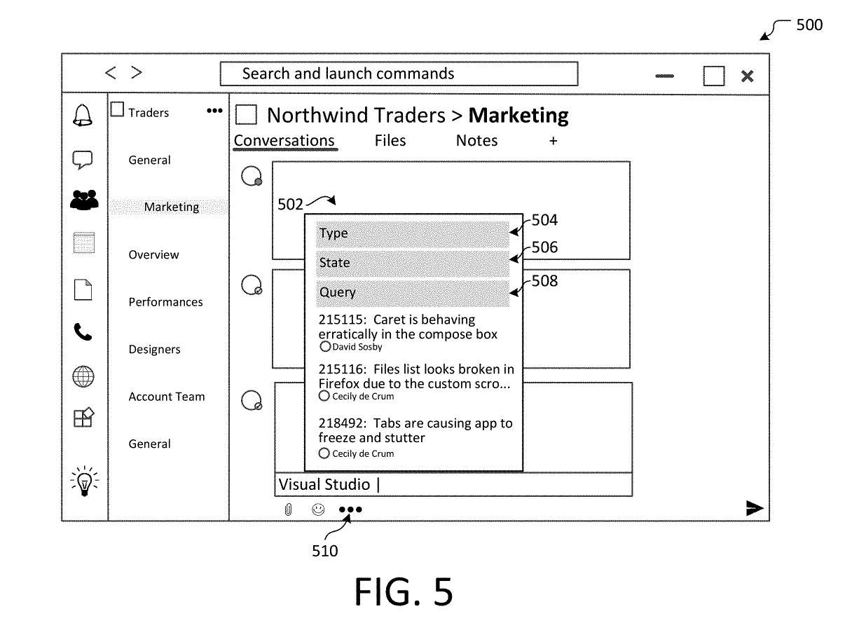

FIG. 5 illustrates an overview of an example graphical user interface 500 relating to command input using robust input parameters. In an example, a client application such as client applications 110 or 112 in FIG. 1 may display aspects discussed below with respect to FIG. 5. GUI 500 comprises a similar user interface as was discussed with respect to FIGS. 4A-4D, but is provided to illustrate that parameters may be presented to a user using a variety of techniques. FIGS. 4A-4D were described above wherein a user may enter information to input fields for parameters sequentially. By contrast, multiple input fields 504-508 are provided to the user as part of command composer 502. In some examples, a user may enter information to input field 504, followed by input fields 506 and 508, wherein the input may be validated at each input. In other examples, multiple inputs may be received from the user prior to evaluating validation logic associated with the parameters.

Command composer 502 may have been activated as a result of interacting with button 510, which may receive a mouse or touch input. Such an input may be a trigger associated with a command, as described above. In some examples, a command may have multiple triggers with which it is associated, such as button 510 and the text string “@Visual Studio” in the instant example. It will be appreciated that other user experience techniques may be used without departing from the spirit of this disclosure.

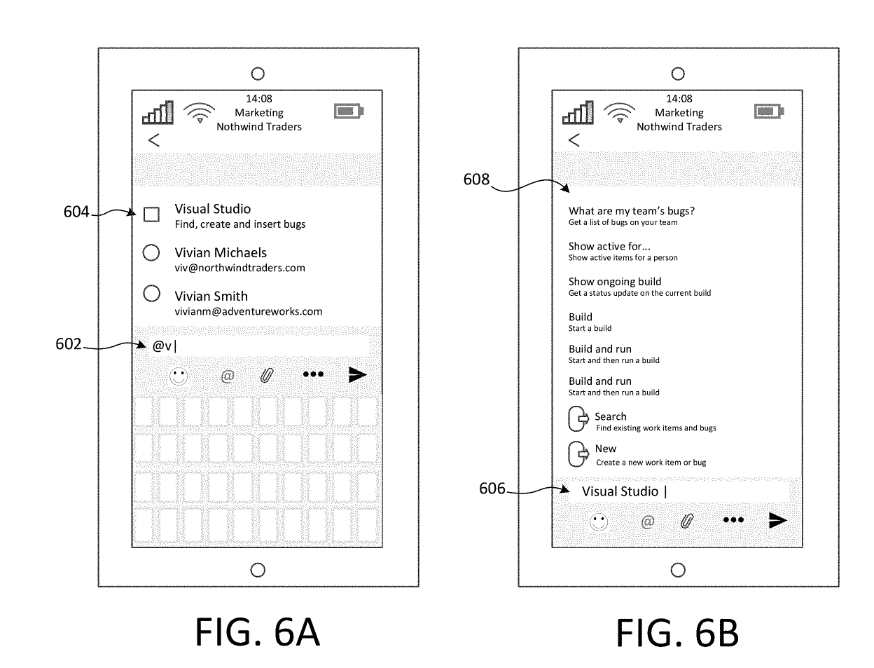

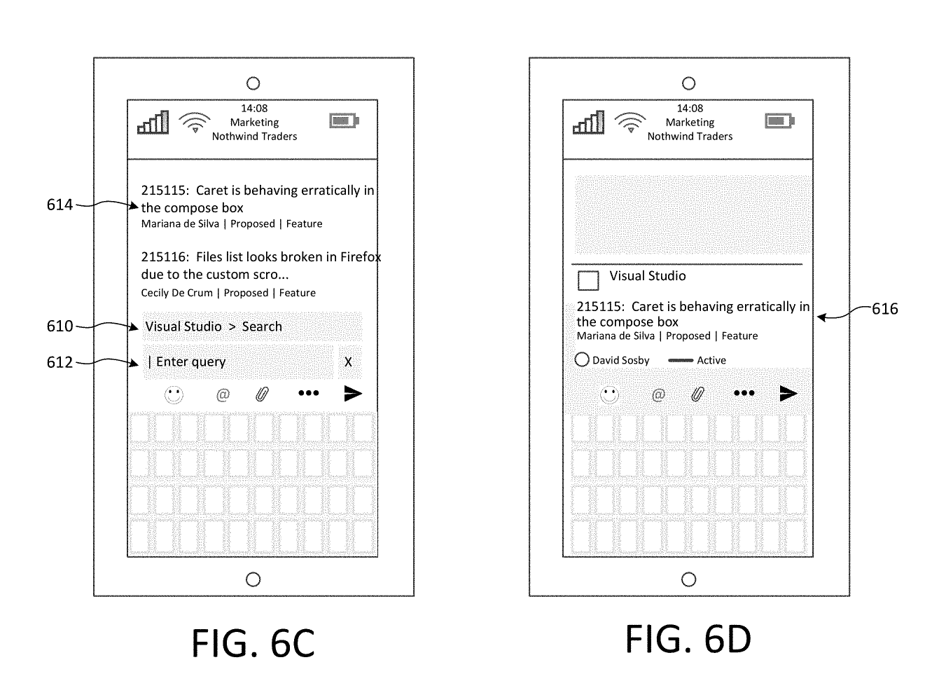

FIGS. 6A-6D illustrate overviews of example graphical user interfaces relating to command input using robust input parameters. Similar to FIGS. 4A-4D, aspects of command input are described with respect to receiving user input comprising a trigger and receiving user input for a plurality of parameters.

Turing to FIG. 6A, an example GUI is illustrated, which comprises input box 602 and autocomplete suggestions 604. In an example, input box 602 may be used by a user to compose electronic messages to communicate with other users. In another example, input box 406 may be used to input commands according to aspects disclosed herein.

As illustrated, a user may input a trigger into input box 602, starting with “@v”. As a result of identifying “@” as an initial trigger, autocomplete suggestions 604 may be presented to the user. In an example, the user may select the command “Visual Studio” from autocomplete suggestions 604. With reference now to FIG. 6B, “Visual Studio” is illustrated as command 606 as a result of a user selecting it from autocomplete suggestions 604 in FIG. 6A. Pick list 608 may be presented to the user, wherein the pick list may be associated with a first parameter of the “Visual Studio” command. In an example, a user may select an entry from pick list 608 by tapping on a pick list entry.

As discussed above, subsequent parameters of a command may vary depending on the input received at current and/or previous parameters. With reference to FIG. 6C, a user may have selected “Search” from pick list 608 in FIG. 6B, as illustrated by confirmed input fields 610. A next input field may be displayed, as depicted by input field 612. In some examples, a user may return to previous input fields to change the input that was previously provided. In some examples, subsequent inputs that were received after the user's revised input may no longer be relevant and may be reset. In other examples, the user may continue based on the previously-provided input.

Input field 612 is a text-entry input, wherein the user may enter a query, as indicated by the descriptive text (“Enter query”) of input field 612. As a result, an on-screen keyboard may be displayed with which the user may enter text. Suggestions 614 may update based on input received from the user, such that the user may select a suggestion displayed by suggestions 614 as input for input field 612. In some examples, the user may move in between input fields using any of a variety of techniques, including gestures and/or virtual or physical buttons, among others. A command may be submitted based on determining that there are no remaining parameters for which user input should be received, or based on determining that received user input is sufficient (e.g., required parameters have been entered) to submit the command.

FIG. 6D comprises processing result 616, which may have been generated as a result of submitting the above-discussed parameters. In the instant example, processing result 616 may be a computer bug from Visual Studio that was accessed as a result of user input received at the input fields for parameters of the command as discussed above. A user may then communicate the processing result to other members of the conversation, thereby enabling other users to view the information that the user accessed by composing and submitting the command.

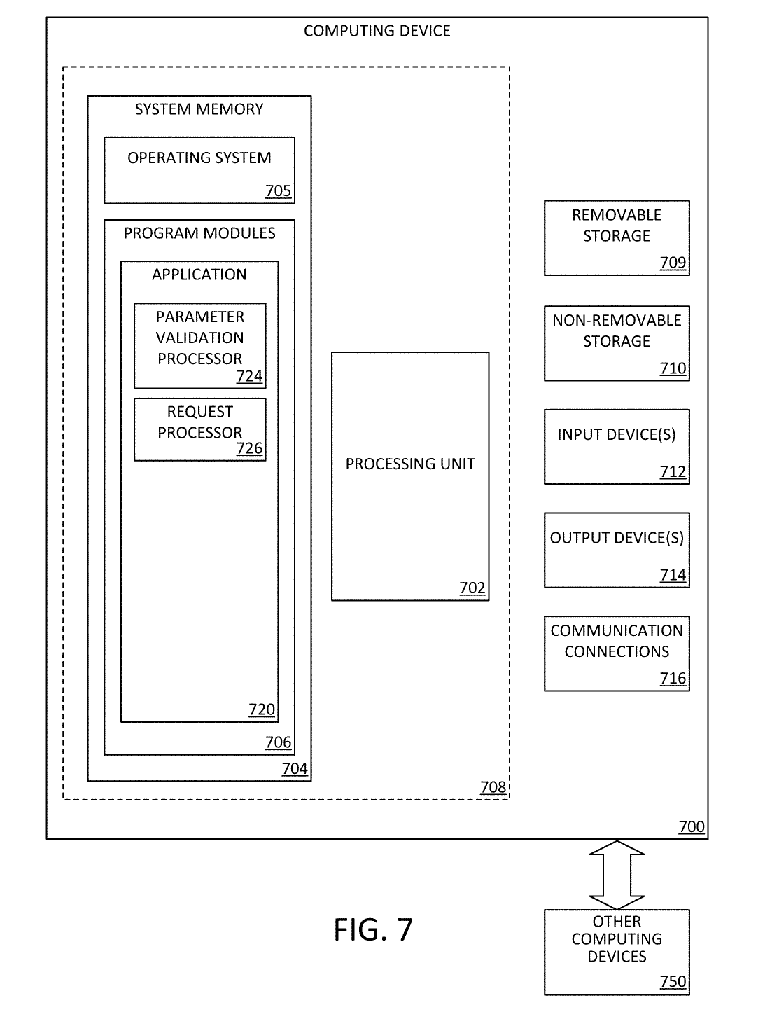

FIGS. 7-10 and the associated descriptions provide a discussion of a variety of operating environments in which aspects of the disclosure may be practiced. However, the devices and systems illustrated and discussed with respect to FIGS. 7-10 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for performing the various aspects disclosed herein such as parameter validation processor 724 and request processor 726. The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

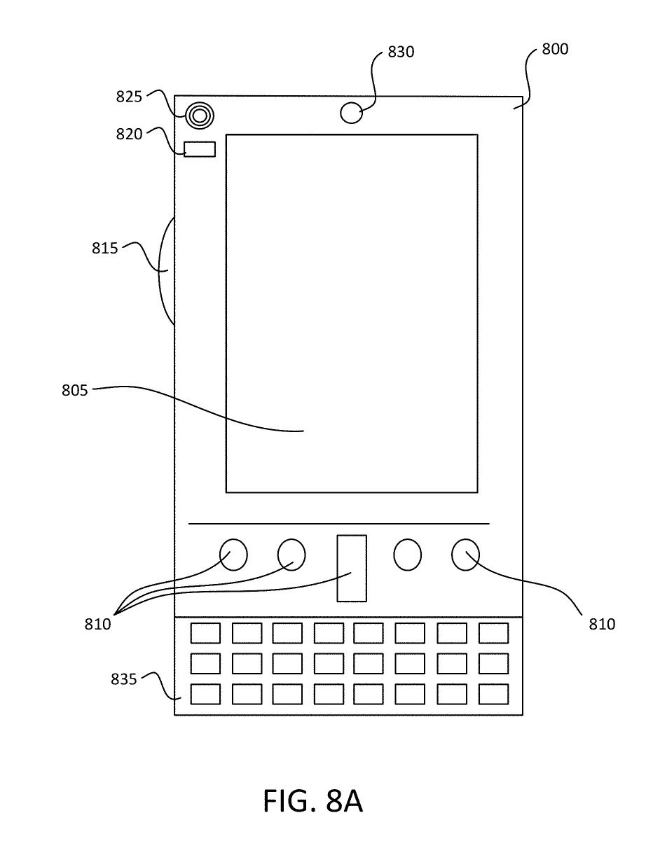

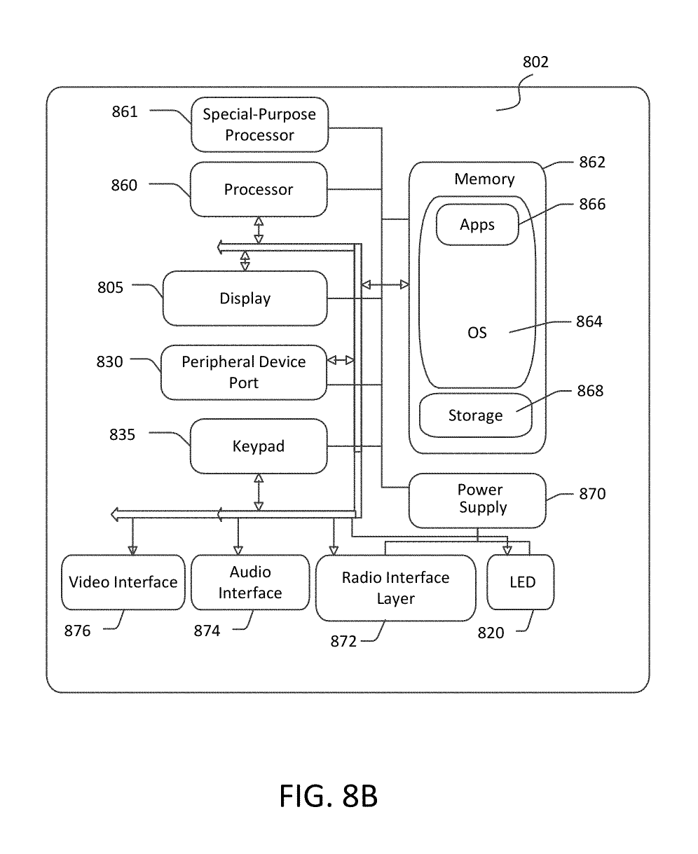

FIGS. 8A and 8B illustrate a mobile computing device 800, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile computing device. That is, the mobile computing device 800 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein (e.g., search engine, extractor module, relevancy ranking module, answer scoring module, etc.).

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

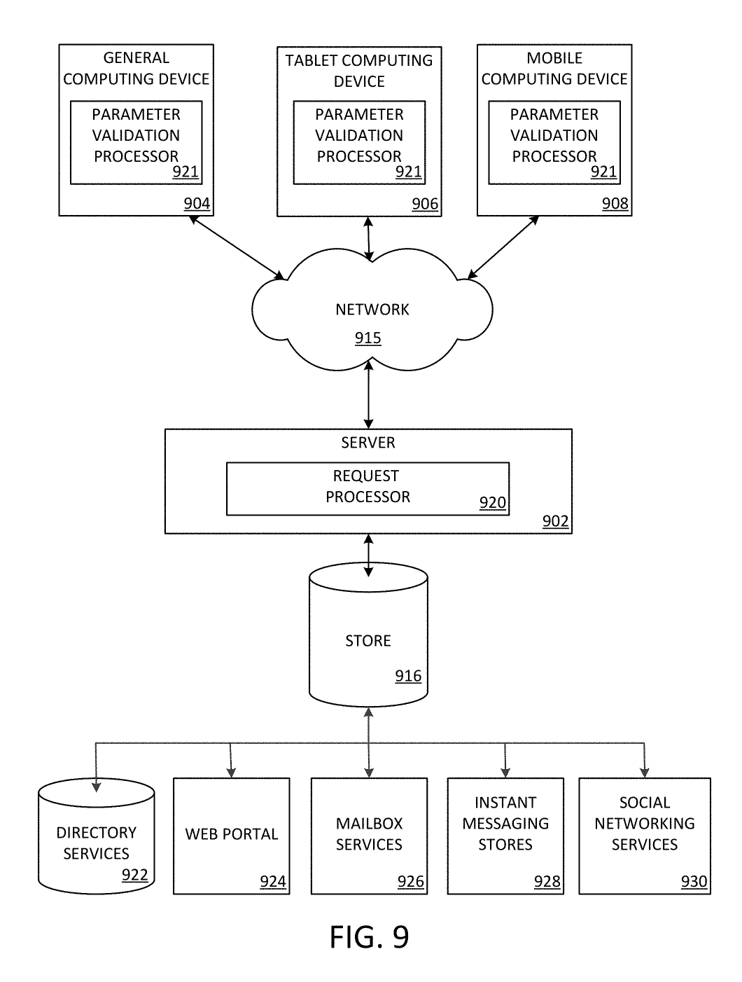

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. Parameter validation processor 921 may be employed by a client that communicates with server device 902, and/or request processor 920 may be employed by server device 902. The server device 902 may provide data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

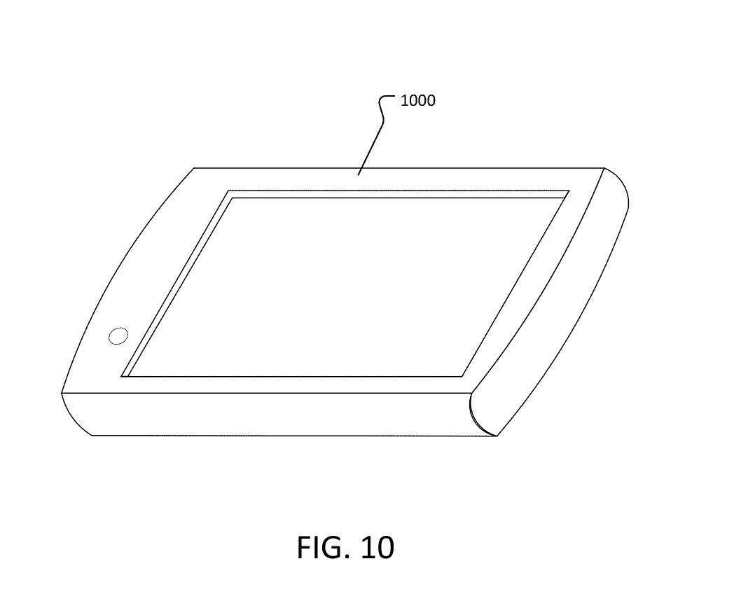

FIG. 10 illustrates an exemplary tablet computing device 1000 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: receiving, at a user device, a first user input, wherein the first user input comprises a trigger associated with a command; identifying a parameter of the command, wherein the parameter is associated with an input type and validation logic; generating, based on the input type, an input field for the parameter; receiving a second user input at the input field, wherein the second user input comprises a confirmation action; determining, using the validation logic, whether the second user input is valid; based on determining that the second user input is valid, validating the parameter; and invoking the command based at least in part on the validated parameter. In an example, the set of operations further comprises: identifying a subsequent parameter of the command; generating a second input field for the subsequent parameter; receiving a third user input at the second input field; and determining, using validation logic associated with the subsequent parameter, whether the third user input is valid. In another example, the parameter is associated with an input description, and wherein the input field comprises an input description associated with the parameter. In a further example, the set of operations further comprises: based on determining that the third user input is not valid, generating a request for the user to provide a fourth user input to the second input field. In yet another example, the identified parameter is dynamically generated based on one or more of: user identification information; user authentication information; and a conversation session. In a further still example, the validation logic comprises an external validation reference and determining whether the second user input is valid comprises: generating a request to an external validator based on the external validation reference, wherein the request comprises at least a part of the second user input; and receiving a response from the external validator, wherein the response comprises an indication of whether the second user input is valid. In another example, the confirmation action comprises one of: a keyboard input; a mouse input; and a touch input.

In another aspect, the technology relates to a method for command input using a structured input interface. The method comprises: receiving, at a user device, a first user input, wherein the first user input comprises a trigger associated with a command; generating the structured input interface for the command, wherein the structured input interface comprises a first input field for a first parameter of the command; displaying the structured input interface at the user device; receiving a second user input at the first input field, wherein the second user input comprises a confirmation action; determining, using validation logic associated with the first parameter, whether the second user input is valid; based on determining that the second user input is valid, validating the first parameter; and invoking the command based at least in part on the validated parameter. In an example, the method further comprises: based on validating the first parameter, generating a second input field of the structured input interface, wherein the second input field is associated with a subsequent parameter of the command; receiving a third user input at the second input field; and determining, using validation logic associated with the subsequent parameter, whether the third user input is valid. In another example, the validation logic comprises an external validation reference. In a further example, determining whether the second user input is valid comprises: generating a request to an external validator based on the external validation reference, wherein the request comprises at least a part of the second user input; and receiving a response from the external validator, wherein the response comprises an indication of whether the second user input is valid. In yet another example, the confirmation action comprises one of: a keyboard input; a mouse input; and a touch input. In a further still example, generating the input field comprises displaying an on-screen keyboard on the user device.

In a further aspect, the technology relates to a method for command input using robust input parameters. The method comprises: receiving, at a user device, a first user input, wherein the first user input comprises a trigger associated with a command; identifying a parameter of the command, wherein the parameter is associated with an input type and validation logic; generating, based on the input type, an input field for the parameter; receiving a second user input at the input field, wherein the second user input comprises a confirmation action; determining, using the validation logic, whether the second user input is valid; and based on determining that the second user input is valid, associating the second user input with the parameter. In an example, the method further comprises: identifying a subsequent parameter of the command; generating a second input field for the subsequent parameter; receiving a third user input at the second input field; and determining, using validation logic associated with the subsequent parameter, whether the third user input is valid. In another example, the method further comprises: generating a request to submit the command, wherein the generated request comprises at least a part of the stored second user input. In a further example, the method further comprises: based on determining that the third user input is not valid, generating a request for the user to provide a fourth user input to the second input field. In yet another example, the validation logic comprises an external validation reference. In a further still example, determining whether the second user input is valid comprises: generating a request to an external validator based on the external validation reference, wherein the request comprises at least a part of the second user input; and receiving a response from the external validator, wherein the response comprises an indication of whether the second user input is valid. In another example, generating the input field for the parameter comprises displaying a structured input interface for the command comprising the input field for the parameter.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving, at a user device, a first user input, wherein the first user input comprises a trigger associated with a command;
identifying a parameter of the command, wherein the parameter is associated with an input type and validation logic;
generating, based on the input type, an input field for the parameter;
receiving a second user input at the input field, wherein the second user input comprises a confirmation action;
determining, using the validation logic, whether the second user input is valid;
based on determining that the second user input is valid, validating the parameter; and
invoking the command based at least in part on the validated parameter.

2. The system of claim 1, wherein the set of operations further comprises:
identifying a subsequent parameter of the command;
generating a second input field for the subsequent parameter;
receiving a third user input at the second input field; and
determining, using validation logic associated with the subsequent parameter, whether the third user input is valid.

3. The system of claim 1, wherein the parameter is associated with an input description, and wherein the input field comprises an input description associated with the parameter.

4. The system of claim 2, wherein the set of operations further comprises:
based on determining that the third user input is not valid, generating a request for the user to provide a fourth user input to the second input field.

5. The system of claim 1, wherein the identified parameter is dynamically generated based on one or more of:
user identification information;
user authentication information; and
a conversation session.

6. The system of claim 1, wherein the validation logic comprises an external validation reference, and wherein determining whether the second user input is valid comprises:
generating a request to an external validator based on the external validation reference, wherein the request comprises at least a part of the second user input; and
receiving a response from the external validator, wherein the response comprises an indication of whether the second user input is valid.

7. The system of claim 1, wherein the confirmation action comprises one of:
a keyboard input;
a mouse input; and
a touch input.

8. A computer-implemented method for command input using a structured input interface, comprising:
receiving, at a user device, a first user input, wherein the first user input comprises a trigger associated with a command;
generating the structured input interface for the command, wherein the structured input interface comprises a first input field for a first parameter of the command;
displaying the structured input interface at the user device;
receiving a second user input at the first input field, wherein the second user input comprises a confirmation action;
determining, using validation logic associated with the first parameter, whether the second user input is valid;
based on determining that the second user input is valid, validating the first parameter; and
invoking the command based at least in part on the validated parameter.

9. The computer-implemented method of claim 8, further comprising:
based on validating the first parameter, generating a second input field of the structured input interface, wherein the second input field is associated with a subsequent parameter of the command;
receiving a third user input at the second input field; and
determining, using validation logic associated with the subsequent parameter, whether the third user input is valid.

10. The computer-implemented method of claim 8, wherein the validation logic comprises an external validation reference.

11. The computer-implemented method of claim 10, wherein determining whether the second user input is valid comprises:
generating a request to an external validator based on the external validation reference, wherein the request comprises at least a part of the second user input; and
receiving a response from the external validator, wherein the response comprises an indication of whether the second user input is valid.

12. The computer-implemented method of claim 8, wherein the confirmation action comprises one of:
a keyboard input;
a mouse input; and
a touch input.

13. The computer-implemented method of claim 8, wherein generating the input field comprises displaying an on-screen keyboard on the user device.

14. A computer-implemented method for command input using robust input parameters, comprising:
receiving, at a user device, a first user input, wherein the first user input comprises a trigger associated with a command;
identifying a parameter of the command, wherein the parameter is associated with an input type and validation logic;
generating, based on the input type, an input field for the parameter;
receiving a second user input at the input field, wherein the second user input comprises a confirmation action;
determining, using the validation logic, whether the second user input is valid; and
based on determining that the second user input is valid, associating the second user input with the parameter.

15. The method of claim 14, further comprising:
identifying a subsequent parameter of the command;
generating a second input field for the subsequent parameter;
receiving a third user input at the second input field; and
determining, using validation logic associated with the subsequent parameter, whether the third user input is valid.

16. The method of claim 14, further comprising:
generating a request to submit the command, wherein the generated request comprises at least a part of the stored second user input.

17. The method of claim 15, further comprising:
based on determining that the third user input is not valid, generating a request for the user to provide a fourth user input to the second input field.

18. The method of claim 14, wherein the validation logic comprises an external validation reference.

19. The method of claim 18, wherein determining whether the second user input is valid comprises:
generating a request to an external validator based on the external validation reference, wherein the request comprises at least a part of the second user input; and
receiving a response from the external validator, wherein the response comprises an indication of whether the second user input is valid.

20. The method of claim 14, wherein generating the input field for the parameter comprises displaying a structured input interface for the command comprising the input field for the parameter.
